(19) United States
(12) Patent Application Publication
(10) Pub. No.: US 2008/0276179 A1
(43) Pub. Date: Nov. 6, 2008

(54) Monitoring and Aggregating User Activities in Heterogeneous Systems

(75) Inventors: Jay B. Borenstein, Palo Alto, CA (US); Thaddeus Jampol, San Francisco, CA (US); Donald F. Coleman, San Francisco, CA (US)

Correspondence Address: FENWICK & WEST LLP, SILICON VALLEY CENTER, 801 CALIFORNIA STREET, MOUNTAIN VIEW, CA, 94041, US

(73) Assignee: IntApp Inc., Palo Alto, CA (US)

(21) Appl. No.: 11/744,845

(22) Filed: May 5, 2007

(51) Int. Cl. G06F 15/177

(52) U.S. Cl. 715/736

(57) ABSTRACT

A system, method, and computer program product for monitoring and aggregating user activities across heterogeneous systems. The system, method, and computer program product retrieve information about the heterogeneous systems and rules, monitor user activities in the heterogeneous systems according to the rules, reconcile the user activities by providing supplemental information, aggregate the monitored activities, and report the aggregated user activities to authorized users.

### BACKGROUND OF THE INVENTION

1. Field of the Invention

This invention pertains in general to data processing and communications, and in particular to monitoring and aggregating user activities in heterogeneous systems.

2. Description of the Related Art

As computers and networks proliferate, and become more powerful and affordable, business activities are increasingly conducted using multiple computers (or computer systems). Enterprises are also equipping their employees with arrays of computers and portable electronic devices to facilitate these business activities. As a result, activities of a particular business matter often take place across multiple computer systems (e.g., an email system, a document management system, and a phone system) and over the course of a significant period of time.

Conducting business activities across several computer systems creates challenges in effectively tracking these business activities. Because activities of a particular business matter may be carried out on multiple computer systems and devices, the tracking needs to be done universally across systems and devices in order to be effective. Effective tracking has important business purposes. For example, timekeeper-based entities such as law firms provide services to clients and charge the clients for the time spent delivering the services. Incorrect tracking of time will cause incorrect billing, thereby impacting the revenue of such entities.

One conventional approach to tracking user activities across multiple systems is to manually analyze electronic logs in the computer systems for logged activities (or operations), identify business matters corresponding to the logged activities, and categorize the logged activities accordingly. This approach introduces the risk for human errors by relying on individuals to track user activities. Also, as the number of systems and devices in which user activities are tracked grows, it quickly becomes impractical for individuals to perform the task.

Another conventional approach tracks user activities across multiple computers by installing a module in each of the multiple computers. The module captures user activities by filtering the traffic of the associated system and stores the captured user activities for future use. This approach slows down the associated systems and causes their performance to suffer. Also, this approach is inefficient because the module does not use the tracking features provided by the associated system, which tends to be more efficient because it is integrated into the system. Further, installing, administering, or updating these modules requires interacting with each individual computer on which they are installed, which is both intrusive and administratively inefficient.

Therefore, there is a need in the art for a way to monitor and aggregate user activities across multiple systems.

### BRIEF SUMMARY OF THE INVENTION

The above need is met by a system, method, and computer program product for monitoring and aggregating user activities across heterogeneous systems. In one embodiment, the system includes a monitor module that monitors user activities in the heterogeneous systems. The system also includes a reconciliation module and an aggregation and analysis module that supplement the monitored activities with additional information and aggregate related user activities. The system also includes a report module that provides the aggregated user activities to authorized users.

In another embodiment, the method retrieves information about the heterogeneous systems and rules, monitors user activities in the heterogeneous systems according to the rules, reconciles the user activities to provide supplemental information, aggregates the monitored activities, and reports the aggregated user activities to authorized users.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

FIG. 1 is a high-level block diagram of a computing environment for monitoring and aggregating user activities across multiple systems according to one embodiment.

FIG. 2 is a high-level block diagram illustrating a functional view of a computer for use as one of the entities illustrated in the environment of FIG. 1 according to one embodiment.

FIG. 3 is a high-level block diagram illustrating modules within an activity aggregation server illustrated in the environment of FIG. 1 according to one embodiment.

FIG. 4 is a flowchart illustrating steps performed by the activity aggregation server to monitor and aggregate user activities across multiple systems according to one embodiment.

The figures depict an embodiment of the present invention for purposes of illustration only. One skilled in the art will readily recognize from the following description that alternative embodiments of the structures and methods illustrated herein may be employed without departing from the principles of the invention described herein.

### DETAILED DESCRIPTION OF THE PREFERRED EMBODIMENTS

### 1. Overview

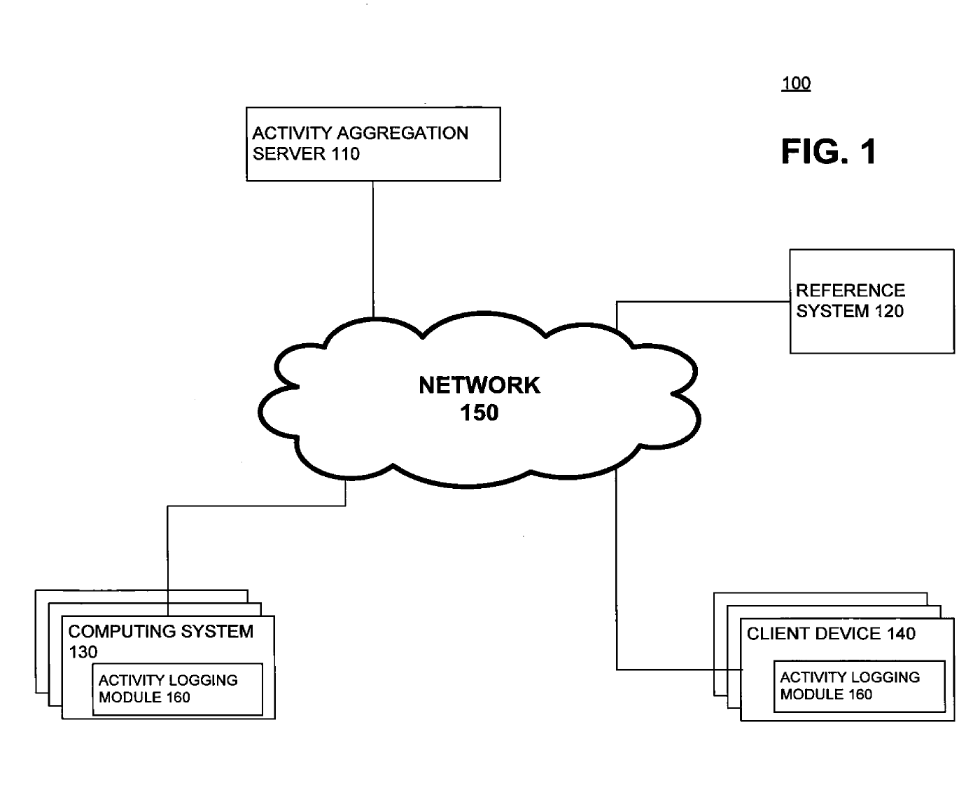

FIG. 1 is a high-level block diagram of a computing environment 100 for monitoring and aggregating user activities across multiple systems according to one embodiment. The computing environment 100 includes an activity aggregation server (also referenced as a “server”) 110, a reference system 120, multiple computing systems 130 and multiple client devices 140, all connected to a network 150.

A user activity is one or a collection of actions conducted by a user related to a specific task. For example, reading an email message is a user activity. This activity can include one or more of the following actions: opening the email message, scrolling the message up and down, and closing the email message. As another example, editing a document can be a user activity, which may include opening the document, modifying the content of the document, and saving the modified document. A record describing a user activity can have one or more attributes, each describing an aspect of the user activity. Examples of the attributes include user name, client phone number, starting time, duration, and description.

Multiple user activities can be related to the same business matter (or business activity). For example, reviewing documents, interviewing witnesses, and drafting motions are all distinctive user activities. However, they can all be related to the same business matter—litigating a case for a client.

The activity aggregation server 110 is a hardware and/or software device that monitors and aggregates user activities in the computing systems 130 and client devices 140, and reports the aggregated user activities to authorized users. In one embodiment, the server 110 can be configured to monitor user activities within an enterprise. The enterprise can be any organization created for one or more goals (e.g., a company, a partnership, a government agency, etc.).

The server 110 can monitor the user activities according to one or more monitor rules. A monitor rule defines how the server 110 monitors the user activities. It can limit the user activities subject to monitoring based on the nature of the activities (e.g., no monitoring of phone calls shorter than two minutes). It can also limit the monitored activities based on the related subject (e.g., monitor all user activities related to client XYZ Corp.). A monitor rule can be applicable to one, a few, or all of the computing systems 130 and/or the client devices 140. It can also be applicable to an individual user or a group of users (e.g., monitor user activities for attorneys but not staff members). For example, a monitor rule can prohibit the server 110 from monitoring phone calls on mobile phones during non-business hours.

The security policy server 110 can aggregate the monitored user activities according to one or more aggregation rules. An aggregation rule defines how the server 110 aggregates the user activities. It can specify aggregations based on attributes such as subject matter, user identity, and client identity. For example, an aggregation rule can instruct the server 110 to aggregate user activities based on user identity and client identity on a daily basis. As a result, activities of a user are grouped together daily based on the related client. As described in detail below, the server 110 retrieves information from the reference system 120 to facilitate the aggregation.

The server 110 can also conduct analyses (e.g., organizing, filtering, or editing) of the monitored user activities according to one or more analysis rules. An analysis rule defines how the server 110 analyzes the user activities. For example, an analysis rule can instruct the server 110 to identify all users working for a particular client. As another example, the server 110 can determine the total resources (e.g., documents printed, time spent) involved in a particular business matter by aggregating all user activities related to the matter.

The server 110 can report the aggregation result and/or the analysis result to authorized users according to one or more report rules. A report rule can identify the authorized recipient(s) and associated aggregation rule(s) and/or analysis rule(s), and determine how the result is reported to the authorized users. For example, a report rule and associated aggregation rule(s) can instruct the server 110 to email a daily summary of all user activities related to a particular client to a manager in charge of the client. In one embodiment, the server 110 transmits the results to a resource management system (e.g., a time tracking system) and reports to the authorized users through a user interface of the resource management system.

The reference system 120 is a hardware and/or software device that provides supplemental information for the activity aggregation server 110 to aggregate and analyze user activities. The supplemental information can include business matter information (e.g., description and identifier (e.g., matter number)), client information (e.g., name, identifier (e.g., client number), contact information (e.g., phone number, email address, postal mailing address)), user information (e.g., name, email address, phone number), and the like. The reference system 120 can include a customer relationship management (CRM) system (e.g., sales force management systems), a personal information management system (e.g., Microsoft Outlook), and/or a human resource management systems (e.g., Oracle Human Resource Management System).

A computing system 130 is a hardware and/or software device for providing services to users. Examples of the services provided by a computing system 130 include a document management service, an email service, and an appointment calendar service. Typical examples of computing systems 130 include document management systems (e.g., Hummingbird DOCS Open, Rational ClearCase), mail systems (e.g., Microsoft Exchange), web servers (e.g., Apache HTTP Server), and the like.

A client device 140 is a hardware and/or software device for users to conduct business activities and/or access the computing systems 130. Examples of a client device 140 include a personal computer (laptop or desktop), a mobile phone, an Internet Protocol (IP) phone, and a personal digital assistant (PDA). The client device 140 can have one or more operating systems such as Microsoft Windows, LINUX, and/or a variant of UNIX. The computing systems 130 and the client device 140 are collectively called heterogeneous systems.

In one embodiment, each of the heterogeneous systems includes an activity logging module 160 that records user activities occurring in the heterogeneous system. In one embodiment, an activity logging module 160 can be configured according to the monitor rules to record only certain information. For example, the activity logging module 160 of a mail system can be configured to only record the source address, destination address, subject, and keywords of each email, rather than to record the complete email. The server 110 can monitor user activities in a heterogeneous system by retrieving the recorded user activities from the activity logging module 160 residing on the heterogeneous system.

The activity logging module 160 can be provided by the heterogeneous system. For example, a document management system such as Hummingbird DOCS Open provides an activity logging module 160 that traces user activities (e.g., edit, check-in, check-out, print, and access) affecting documents stored in the system. Other hardware and/or software applications can also include activity logging modules 160 to record user activities. For example, web browsers such as Microsoft Internet Explorer records users' web browsing activities. As another example, mobile phones track phone calls in call logs. The activity logging module 160 can also be provided separately. For example, an activity logging module 160 can be installed in a laptop computer to monitor user activities occurred in the computer.

In one embodiment, the server 110, the reference system 120, and the heterogeneous systems may be stored and operated on a single computer or on separate computer systems communicating with each other through the network 150.

The network 150 represents the communication pathways between the activity aggregation server 110, the reference system 120, and the heterogeneous systems. In one embodiment, the network 150 is a private enterprise network. In another embodiment, the network 150 is the Internet or includes portions of the Internet. In one embodiment, the network 150 carries traffic using standard communications technologies and/or protocols. Thus, the network 150 can include links using technologies such as Ethernet, 802.11, integrated services digital network (ISDN), digital subscriber line (DSL), asynchronous transfer mode (ATM), etc. Similarly, the networking protocols used by traffic on the network 150 can include multiprotocol label switching (MPLS), the transmission control protocol/Internet protocol (TCP/IP), the hypertext transport protocol (HTTP), the simple mail transfer protocol (SMTP), the file transfer protocol (FTP), etc. The data exchanged over the network 150 can be represented using technologies and/or formats including the hypertext markup language (HTML), the extensible markup language (XML), etc. In addition, all or some of links can be encrypted using conventional encryption technologies such as the secure sockets layer (SSL), Secure HTTP and/or virtual private networks (VPNs). In another embodiment, the entities can use custom and/or dedicated data communications technologies instead of, or in addition to, the ones described above.

### 2. System Architecture

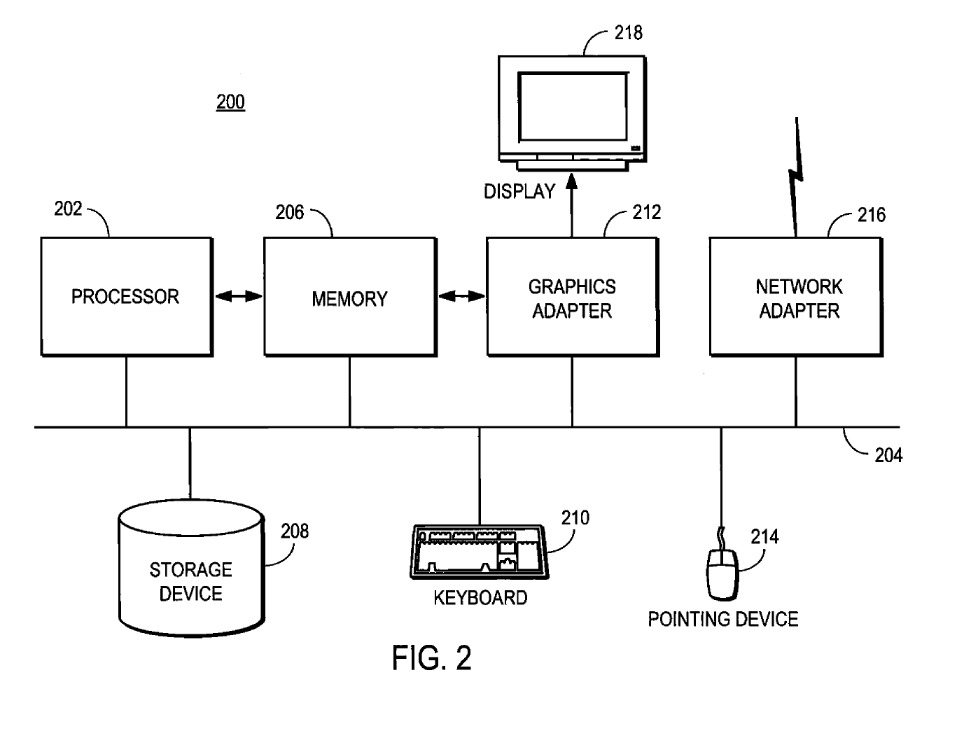

FIG. 2 is a high-level block diagram illustrating a functional view of a computer 200 for use as one of the entities illustrated in the environment 100 of FIG. 1 according to one embodiment. Illustrated are at least one processor 202 coupled to a bus 204. Also coupled to the bus 204 are a memory 206, a storage device 208, a keyboard 210, a graphics adapter 212, a pointing device 214, and a network adapter 216. A display 218 is coupled to the graphics adapter 212.

The processor 202 may be any general-purpose processor such as an INTEL x86 compatible-CPU. The storage device 208 is, in one embodiment, a hard disk drive but can also be any other device capable of storing data, such as a writeable compact disk (CD) or DVD, or a solid-state memory device. The memory 206 may be, for example, firmware, read-only memory (ROM), non-volatile random access memory (NVRAM), and/or RAM, and holds instructions and data used by the processor 202. The pointing device 214 may be a mouse, track ball, or other type of pointing device, and is used in combination with the keyboard 210 to input data into the computer system 200. The graphics adapter 212 displays images and other information on the display 218. The network adapter 216 couples the computer 200 to the network 150. In many instances the computer lacks one or more of the elements shown in FIG. 2, such as a keyboard 210, pointing device 214, graphics adaptor 212, and/or display 218.

As is known in the art, the computer 200 is adapted to execute computer program modules. As used herein, the term “module” refers to computer program logic and/or data for providing the specified functionality. A module can be implemented in hardware, firmware, and/or software. In one embodiment, the modules are stored on the storage device 208, loaded into the memory 206, and executed by the processor 202.

The types of computers 200 utilized by the entities of FIG. 1 can vary depending upon the embodiment and the processing power required by the entity. A client device 140 might be a single computer 200. Each of the systems 120, 130 and 150, in contrast, might be provided by a server running on a more powerful computer and/or one or more blade servers operating in tandem. Likewise, in one embodiment the activity aggregation server 110 comprises one or more modules executing on one or more blade servers or other types of computers working together to provide the functionality described herein.

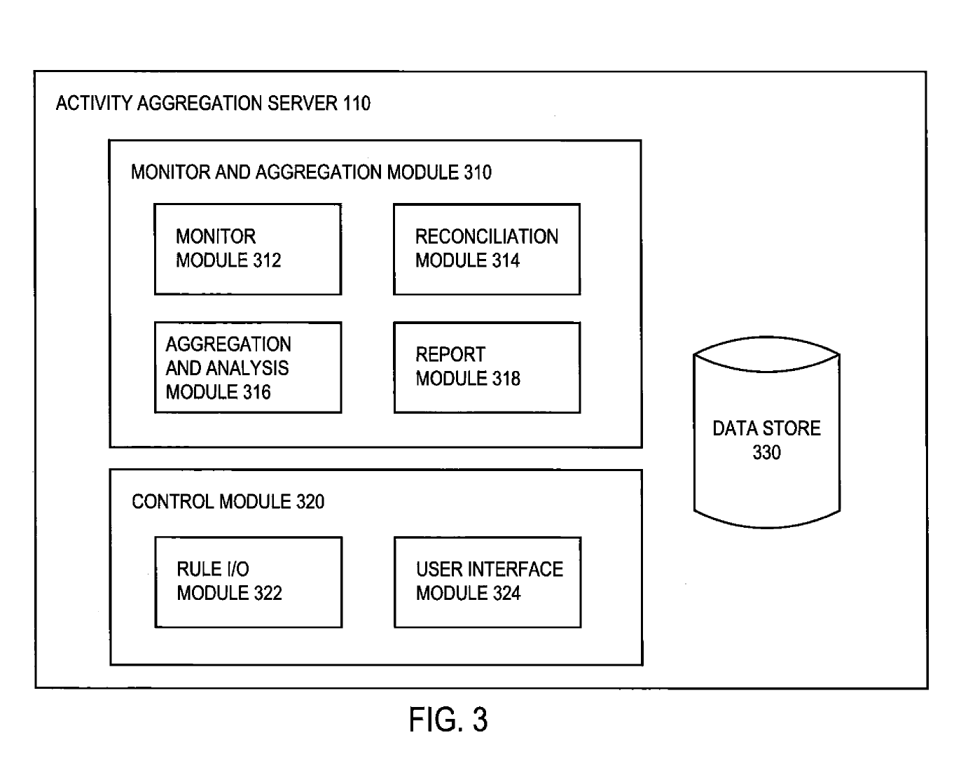

FIG. 3 is a high-level block diagram illustrating modules within the activity aggregation server 110 according to one embodiment. Other embodiments have additional and/or different modules than the ones shown in the figure. In addition, the functionalities can be distributed among the modules in a manner different than described here. Further, some of the functions can be provided by entities other than the activity aggregation server 110. As illustrated in FIG. 3, the server 110 includes a monitor and aggregation module 310, a control module 320, and a data store 330.

The monitor and aggregation module 310 is designed to monitor user activities in the heterogeneous systems, reconcile the user activities, aggregate the related user activities, and report the aggregation result to designated users. The monitor and aggregation module 310 includes a monitor module 312, a reconciliation module 314, an aggregation and analysis module 316, and a report module 318.

The monitor module 312 is configured to monitor (or track) user activities in the heterogeneous systems. In one embodiment, the monitor module 312 monitors the user activities in a heterogeneous system by retrieving user activities recorded (or logged) by the activity logging module 160 in the heterogeneous system. The heterogeneous systems can be identified to the monitor module 312 by user input. Alternatively, the monitor module 312 can retrieve information about the heterogeneous systems from sources such as a directory service of the computing environment 100.

Depending on how the heterogeneous systems and the activity logging modules 160 are configured, the monitor module 312 may retrieve the recorded user activities using different mechanisms. The monitor module 312 can submit retrieval requests to some activity logging modules 160 by making Application Program Interface (API) calls. Alternatively, the monitor module 312 can interact with the heterogeneous system to retrieve computer files storing the recorded user activities (e.g., log files). The different mechanisms can be provided by authorized users (e.g., administrators) or by sources such as a directory service. The monitor module 312 can store information about the mechanisms, the heterogeneous systems and the activity logging module 160 in the data store 330.

The monitor module 312 can be configured to retrieve some or all of the information recorded about the user activities. For example, the monitor module 312 can be configured to query some activity logging modules 160 for detailed information about the user activities, while only query others for brief descriptions. As another example, the monitor module 312 can request only those user activities not prohibited by the monitor rules.

In one embodiment, the monitor module 312 can be configured to periodically query (or retrieve data from) the heterogeneous systems (or the activity logging modules 160 within the systems) for recorded user activities. The monitor module 312 can use computer protocols supported by the heterogeneous systems (e.g., HTTP, FTP, Structured Query Language (SQL), and web services) to query the user activities. Alternatively, the monitor module 312 can be configured to retrieve recorded user activities when a specific event occurs. For example, the monitor module 322 can retrieve a phone call history from a mobile phone whenever the mobile phone is accessible through the network 150 (e.g., when the mobile phone is synchronizing with a computing system 130). The monitor module 312 can set up triggers in the heterogeneous systems (or the activity logging modules 160 within the systems) that can be activated by user activities (e.g., document check-in/out, phone call initiation/termination) or elapse of time. Once activated, the triggers can instruct local applications or the activity logging modules 160 to retrieve information about the user activity and transmit it to the monitor module 312. For example, the monitor module 312 can set up database triggers in a database system to monitor user activities affecting the content of a particular database table, such that such user activities will be monitored by the monitor module 312 in real time.

The monitor module 312 can be configured to convert the retrieved user activity records into a standard format. Different activity logging modules 160 may record user activities in different formats. For example, one activity logging module 160 may record time using 12-hour format, another activity logging module 160 may record time using 24-hour format. As another example, one activity logging module 160 can record user activities in generic XML format, while another activity logging module 160 records in plain text format. One example of the standard format is the Standard Generalized Markup Language (SGML). In one embodiment, the monitor module 312 performs the conversion based on one or more conversion rules. A conversion rule defines how the monitor module 312 converts the retrieved user activity records into a standard format. For example, a conversion rule can convert time value in 12-hour format into equivalent time value in 24-hour format. The conversion rules can be determined by authorized users and stored in the data store 330. In one embodiment, the monitor module 312 can be configured to store a record of monitored user activities in the data store 330.

The reconciliation module 314 is configured to provide supplemental information for user activities. As described above with reference to FIG. 1, a user activity record may have multiple attributes describing different aspects of the user activity. Therefore, different records may include different attributes. For example, a user activity record may identify a client by its email address, while another record may identify the same client by its phone number. In one embodiment, the reconciliation module 314 can reconcile the different identification information used in different records by retrieving standardized identification information (or other cross-reference information) from the reference system 120, and add the standardized identification information to the records. For example, assume the standardized identification information for a client is its business name. For a record that identifies the client by its email address, the reconciliation module 314 can identify the client associated with the email address (or the host name of the email address) in the reference system 120, retrieve the name associated with the client from the reference system 120, and add the retrieved name as a new attribute to the record to further describe the user activity.

The user activity record retrieved may not have sufficient information describing the user activity. As described above with reference to FIG. 1, a user activity record may have multiple attributes describing different aspects of the user activity. A record may include attributes about user identity (e.g., login name), attributes describing the user activity, attributes containing context information (e.g., keywords, time), and the like. An activity logging module 160 may not record all of this information. For example, a phone record may not identify the subjects of the phone calls. The reconciliation module 314 can retrieve additional information to further describe the user activities. As an example, the reconciliation module 314 can retrieve information such as appointments, tasks, and to-do lists from a user's calendar system and match with the user's activities. If the reconciliation module 314 locates a match (e.g., the phone number of a recorded phone call matches an appointment entry), the reconciliation module 314 can use the descriptive information in the appointment entry to further describe the recorded phone call. In one embodiment, the reconciliation module 314 can retrieve supplemental information from several sources.

The reconciliation module 314 can be configured to identify duplicate user activities. The same user activity may be recorded by different heterogeneous systems or applications. For example, assume a user used his personal computer to access a document stored in a document management system. This document access activity is recorded both in the personal computer and in the document management system. The reconciliation module 314 can recognize that the two records describe the same user activity (duplicate records) by their content. For example, the record in the personal computer may identify the document management system as the source of the document. The document management system may also identify the personal computer as the source of the document access request. Based on the above information (as well as other matching attributes such as time), the reconciliation module 314 can determine that the two records are duplicate records.

The reconciliation module 314 can be configured to combine the identified duplicate records. Even though duplicate records describe the same user activity, they may contain different attributes. Continuing with the above document access example, the record in the personal computer can include the user's usage of the document (e.g., the user stored a copy of the document in an external storage device), and the record in the document management system can include metadata about the document (e.g., the document is marked as highly confidential). The reconciliation module 314 can combine the duplicate records into a record including attributes from each of the duplicate records. The reconciliation module 314 can combine the duplication records in different manners. For example, the reconciliation module 314 can keep one of the duplicate records (the surviving record) and remove the rest. Alternatively, the reconciliation module 314 can create a new record to describe the activity and remove all the duplicate records. As described above, the reconciliation module 314 can integrate the information from the duplicate records to the surviving (or newly created) record to describe the user activity. For example, the reconciliation module 314 can use the information from the document management server (e.g., the metadata) to describe the content of the document, and use the information from the personal computer to describe the activities the user performed to the document. In one embodiment, the reconciliation module 314 can prefer information from one source over another. For example, the reconciliation module 314 can prefer identity information from the reference system 120 over information from sources such as an appointment calendar.

The aggregation and analysis module 316 is configured to aggregate the user activities monitored by the monitor module 312. As described above with reference to the server 110 in FIG. 3, the aggregation and analysis module 316 can aggregate the user activities according to one or more aggregation rules. For example, an aggregation rule may instruct the aggregation and analysis module 316 to aggregate the user activities of a particular user based on client. As described above, the reconciliation module 314 adds cross-reference information (or standardized identification information) into the records. Therefore, the aggregation and analysis module 316 can aggregate the user activities based on a unified identification of the client (e.g., the client's business name).

In one embodiment, the aggregation and analysis module 316 aggregates the user activities together by grouping the related user activities together and generating one or more attributes for the group of user activities. One example of such attributes describes each user activity being aggregated. Another such attribute can be the total duration of the user activities. The total duration can be a simple sum of the durations of each individual user activity. In one embodiment, when two or more distinct user activities overlap, the aggregation and analysis module 316 calculates the overlapped time period only once to avoid double counting.

The aggregation and analysis module 316 can be further configured to provide analytical functions to authorized users. As described above with reference to the server 110 in FIG. 3, the aggregation and analysis module 316 can analyze the user activities according to one or more analysis rules. For example, an analysis rule can instruct the aggregation and analysis module 316 to aggregate user activities related to a specific project and to determine whether the project approaches or exceeds its budget.

The report module 318 is configured to report to designated users the aggregation and/or analysis results. As described above with reference to the server 110 in FIG. 1, the report module 318 can report the results to users according to one or more report rules. For example, one report rule may instruct the report module 318 to generate a report for the designated users results aggregated based on an aggregation rule and send the report to the designated users. The report can be electronically communicated to the intended audience in different format, such as emails, voice messages, and mobile phone/pager text messages. The report can list the attributes of the aggregated user activities, such as the associated client name and the description of the user activities aggregated. As another example, a report rule and associated aggregation rule(s) and/or analysis rule(s) may instruct the report module 318 to send a daily summary of aggregated user activities within the enterprise to a designated user. Such daily summary may contain issues such as average time billed per user, total number of documents printed, and the like.

In one embodiment, the report module 318 is configured to report the aggregated user activities to a resource management system. The resource management system can be a system managing resource allocation and/or consumption. Examples of the resource management system include a time tracking system and an accounting application. The report module 318 may send the information to the resource management system via common computer protocols including, but not limited to HTTP, FTP, SQL, and web services. For example, the report module 318 can report the time a user spent in activities related to a matter to the time tracking system. In one embodiment, the resource management system 150 includes a configuration console. The report module 318 can provide a user interface integrated with the configuration console, enabling users to review and edit the reported aggregated user activities and decide whether to bill the time to the client.

The control module 320 allows authorized users to manage the activity aggregation server 110. The control module 320 includes a rule I/O module 322 and a user interface module 324.

The rule I/O module 322 is configured to import and/or export rules from and/or to external sources. In one embodiment, the rule I/O module 322 is configured to periodically backup rules (e.g., monitor rules, reconciliation rules, aggregation rules, analysis rules, and report rules) by exporting them to external sources (e.g., a USB drive) and later restore them by importing as needed (e.g., when the rules become corrupted).

The user interface module 324 is configured to provide an interface for the authorized users (e.g., the system administrators) to configure the server 110 and manage the rules. The interface can be graphical user interface, command-line interface, or web-based user interface. The authorized users can use the interface to set up, configure, and control modules such as the modules 312, 314, 316, 318, 322 and 324, manage the data store 330, and create or modify the rules (e.g., creating, editing, or deleting rules). In one embodiment, a user can set rules applicable to his or her user activities using the user interface module 324.

For example, the authorized users can use the interface to configure the format, content, and intended audience of a report to be sent out by the reporting module 318. Users can access the user interface module 324 remotely through the network 150. In one embodiment, the user interface is integrated with the user interface of a resource management system (e.g., a configuration console of a time tracking system).

The data store 330 is configured to store rules, the monitored user activities, and information about the heterogeneous systems. The rules can include monitor rules, reconciliation rules, aggregation rules, analysis rules, and report rules. The monitored user activities can include information such as user identity (e.g., login name, email alias, employment number, social security number, etc.), client identity (e.g., client name, client number, client billing account number), device identity (e.g., printer name, scanner network address, MAC address, etc.), and electronic content identity (e.g., file/directory name, document identifier, database table identifier). The information about the heterogeneous systems can include the identity of the heterogeneous systems, the methods (or mechanisms) to request the recorded user activities in the heterogeneous systems, the format of the recorded user activities, and the associated conversion rules. In one embodiment, the structured information database 112 is a relational database that supports queries made in SQL. Other embodiments utilize different types of databases.

### 3. Process/Example

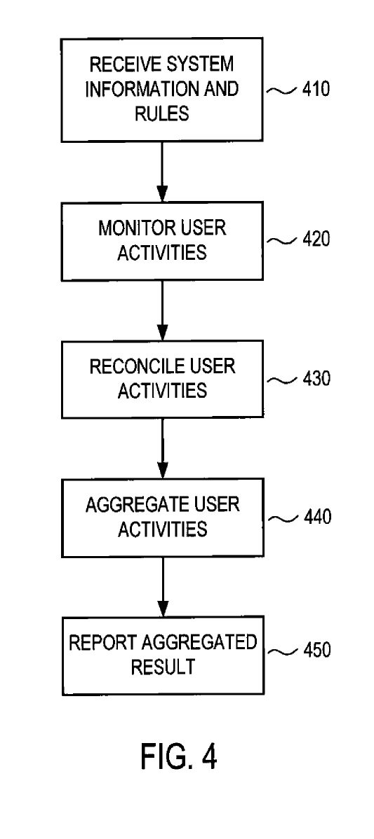

FIG. 4 is a flowchart illustrating steps performed by the activity aggregation server 110 to monitor and aggregate user activities across heterogeneous systems according to one embodiment. Other embodiments perform the steps in different orders and/or perform different or additional steps than the ones shown in FIG. 4. The server 110 can perform multiple instances of the steps of FIG. 4 concurrently and/or perform steps in parallel.

Initially, the monitor module 312 of the server 110 receives 410 system information about the heterogeneous systems and rules. In one embodiment, the heterogeneous systems are configured to record user activities occurring in the systems. The system information includes information that identifies the heterogeneous systems and information about how to retrieve recorded user activities from them. The rules instruct the server 110 how to monitor and aggregate user activities, and report to designated users. The monitor module 312 can receive 410 the system information and the rules from external sources such as a directory service (e.g., Microsoft Active Directory) or the data store 330. Alternatively, this information can be provided by authorized users through the user interface module 324.

The monitor module 312 monitors (or tracks) 420 user activities in the heterogeneous systems. In one embodiment, the monitor module 312 retrieves records of user activity from the heterogeneous systems based on the system information and monitor rules received. The monitor module 312 may also convert the received records of user activity into a standard format according to conversion rules.

The reconciliation module 314 reconciles 430 the monitored user activities by adding supplemental information and removing duplicate records of user activities. The aggregation and analysis module 316 aggregates 440 the user activities by grouping the related user activities together according to aggregation rules. The report module 318 reports 450 (or communicates) the aggregated results to designated users. As described above with reference to FIG. 3, the report module 318 can use a user interface of a resource management system to report the aggregated user actions to the users. Alternatively, the report module 318 can generate a report based on the aggregated results according to a report rule, and send the report to the designated users.

The process described above with regard to FIG. 4 can be further illustrated through an example of an operation of the activity aggregation server 110 in the context of a law firm in accordance with one embodiment. In this example, the computing environment 100 includes, among other heterogeneous systems, a document management system, a calendar server, a laptop computer, and a mobile phone, each of which can be configured to log(or record) users' activities. An attorney uses the laptop computer to review some documents stored in the document management system, writes an email to a client summarizing the document review, and follows up with a phone conference with the client. The laptop computer records the document review and the email correspondence. The document management system logs the document accesses by the attorney. The mobile phone records the phone conference. The calendar server has appointments scheduled for the document review and the phone conference.

The monitor module 312 receives 410 system information for the heterogeneous systems and rules. The system information for the document management system can include brand information (e.g., Hummingbird DM), version information (e.g., version 2003, build 11.2359.2408), network address information (e.g., IP address 139.247.30.178), supported remote function calls, and the format of user activities recorded in the system (e.g., “DATE; TIME; TYPE OF ACTIVITY; VERSION; USER LOGIN”). The rules received include monitor rules designed to track billable time for attorneys. Billable time can be defined as time spent providing professional services to a client that is chargeable (or billable) to the client. One of the monitor rules prohibits monitoring phone calls in the mobile phone between 10 PM and 5 AM.

The monitor module 312 monitors 420 the heterogeneous systems by retrieving the recorded user activities from the heterogeneous systems using the system information and the monitor rules. This retrieval can be performed in different ways. For example, the monitor module 312 can retrieve the phone call history from the mobile phone whenever the phone is connected with the laptop computer (e.g., when the mobile phone is synchronizing with the laptop computer). As another example, the monitor module 312 can retrieve a system log of user activities occurring in the document management system by making a remote function call to the document management system. The monitor module 312 can also convert the retrieved records into a standard format. For example, the mobile phone may log phone calls in plain text format (e.g., “(800) 123-4567; 3:26 PM Mar. 14, 2007; 53:48”), indicating that the phone call is made to the phone number (800) 123-4567 at 3:26 PM, Mar. 14, 2007, and lasts 53 minutes and 48 seconds. The monitor module 312 can convert the plain text record into a generic XML format such as the following:

<Destination Number> (800) 123-4567 </Destination Number>
<Starting Time> 15:26 </Starting Time>
<Starting Date> 03/14/2007 </Starting Date>
<Duration> 53:48 </Duration>

It is noted that the monitor module 312 also converts the starting time from 12-hour time format to 24-hour time format, and converts the starting date to MM/DD/YYYY format.

The reconciliation module 314 reconciles 430 the monitored user activities by identifying and combining duplicate records. The reconciliation module 314 determines that the document review activity retrieved from the laptop computer and the document access activity retrieved from the document management system describe the same user activity, the attorney reviewing the documents. The reconciliation module 314 can make the determination based on the retrieved user activity records. For example, the record retrieved from the document management system indicates that the documents are accessed from the laptop computer (e.g., the destination IP address matches the IP address of the laptop computer). Alternatively, the record retrieved from the laptop computer may indicate that the source of the document is the document management system. The reconciliation module 314 can further confirm that the two records refer to the same user activity by matching the time attribute in the two records. The reconciliation module 314 can create a record for the user activity, the attorney reviewing the documents, and copy attributes of the two duplicate records to the newly created record to describe the user activity.

The reconciliation module 314 reconciles 430 the monitored user activities by providing supplemental information. The record describing the email correspondence identifies the client by the destination email address (e.g., John.Doe@XYZ.com). The reconciliation module 314 can determine the client's identity by searching the destination email address (or the host name, XYZ.com) in the reference system 120 and retrieving related identification information (e.g. client name, phone number). The reconciliation module 314 can add the retrieved identification information into the record or cross reference the information with the email address. Similarly, the reconciliation module 314 can provide supplemental information for the record retrieved from the mobile phone by searching in the reference system 120 for client identification information associated with the phone number (800) 123-4567. The reconciliation module 314 can determine that the phone conference and the scheduled phone call appointment retrieved from the calendar server are duplicate records and use the information in the appointment to further describe the phone conference (e.g., “Call John Joe at XYZ Corp. to discuss the document review.”).

The aggregation and analysis module 316 aggregates 440 the user activities according to aggregation rules. Assume the aggregation rules instruct the aggregation and analysis module 316 to group a user's user activities related to the same client together. The aggregation and analysis module 316 determines that the phone conference, the email correspondence, and the document review are related to the same client by their client identification information (or the cross-reference). Therefore, the aggregation and analysis module 316 aggregates 440 records of the three user activities together and generate a description and a duration attribute for the aggregated user activities. The duration can be the total duration for the three user activities.

The report module 318 reports the aggregated results to a time tracking system. In one embodiment, the report module 318 creates an entry for the aggregated user activities, and uses the description and the duration generated to describe the entry. For example, the entry can be for 5 hours and 42 minutes with a description of “Reviewed five documents related to the incorporation of XYZ corp. for 4 hours and 32 minutes, drafted a summary of document review for 20 minutes and emailed to Mr. John Doe of the XYZ corp. at John.Doe@XYZ.com at 3:45 PM, conference call with Mr. John Doe of the XYZ corp. at (800) 123-456 at 3:50 PM and lasted 50 minutes.” The report module 318 can also send a notice email to the attorney (or other authorized users) summarizing the user activities and/or the aggregate user activities. The attorney is reminded by the email of his or her user activities and can edit the entry created in the time tracking system.

The aggregation and analysis module 316 can also analyze the user activities according to analysis rules. For example, an analysis rule can check whether the document review exceeds its budget (e.g., five hours). If the aggregation and analysis module 316 determines that the attorney exceeds the allocated budget, the report module 318 can send an alert to the attorney. As another example, an authorized user (e.g., a billing partner of a law firm) can also set a rule to receive a summary of all billable time spent on a client during a fixed period of time. This summary can also include information such as meals ordered and paper printed/copied. The authorized user can decide whether to bill the expenses to the client.

The disclosed system and method can monitor user activities in heterogeneous systems and aggregate related user activities. Therefore, it can provide users with summaries and complete lists of business activities performed, thereby minimizing the risk of forgetting to bill the client billable times used to provide professional services using several systems. It also provides a central place to track, analyze, and control user activities conducted on multiple heterogeneous systems and related to different business activities. The system and method can also automatically track time and generate description for the user activities, therefore saving user time to prepare billing documents.

The above description is included to illustrate the operation of the preferred embodiments and is not meant to limit the scope of the invention. The scope of the invention is to be limited only by the following claims. From the above discussion, many variations will be apparent to one skilled in the relevant art that would yet be encompassed by the spirit and scope of the invention.

What is claimed is:

1. A method for monitoring and aggregating user activities across a plurality of heterogeneous systems in an enterprise network, comprising:
retrieving data describing monitored user activities from the plurality of heterogeneous systems, the plurality of heterogeneous systems generating the data responsive to the monitored user activities occurring in the plurality of heterogeneous systems;
reconciling the monitored user activities by retrieving supplemental information related to the monitored user activities from a reference system;
aggregating related user activities using the supplemental information to generate an aggregation result, the related user activities being among the monitored user activities; and
reporting the aggregation result to an authorized user.

2. The method of claim 1, wherein at least one of the plurality of heterogeneous systems comprises a system selected from a group consisting of: a document management system, a mail system, a calendar system, a web server, a personal computer, a mobile phone, an Internet Protocol phone, and a personal digital assistant.

3. The method of claim 1, wherein at least one of the plurality of heterogeneous systems has a tracking function for recording local user activities and for generating data describing the local user activities, wherein retrieving the data describing the monitored user activities comprises:
accessing the tracking function of the at least one of the plurality of heterogeneous systems; and
retrieving the data describing the monitored user activities from the tracking function.

4. The method of claim 1, wherein retrieving the data describing the monitored user activities comprises retrieving the data from at least one of the plurality of heterogeneous systems through an Application Program Interface supported by the at least one of the plurality of heterogeneous systems.

5. The method of claim 1, wherein aggregating the related user activities comprises:
identifying a plurality of different user activities, at least two of the plurality of different user activities occurring in different heterogeneous systems;
determining that the plurality of different user activities are related; and
aggregating the plurality of related different user activities into the aggregation result.

6. The method of claim 1, further comprising converting the data describing the monitored user activities into a standard format.

7. The method of claim 1, wherein reconciling the monitored user activities comprises:
identifying data describing a same user activity; and
combining the data describing the same user activity into combined data describing the same user activity, wherein retrieving the supplemental information comprises retrieving supplemental information related to the same user activity based on the combined data.

8. The method of claim 1, wherein the supplemental information comprises cross-referencing information, and wherein aggregating the related user activities comprises:
aggregating the related user activities using the cross-referencing information to generate the aggregation result.

9. The method of claim 1, wherein aggregating the related user activities comprises aggregating the related user activities based on an attribute of the related user activities, the attribute selected from a group consisting of: a client who is related to the related user activities, a user who performed the related user activities, a business matter related to the related user activities, and a date when the related user activities occurred.

10. The method of claim 1, wherein aggregating the related user activities comprises:
generating an attribute for the aggregated related user activities, the attribute comprising at least one selected from a group consisting of: a description of the related user activities, a total amount of time for the related user activities, and a common client of the related user activities,
wherein the aggregation result comprises the attribute.

11. The method of claim 1, wherein reporting the aggregation result comprises outputting information related to the aggregation result to a resource management system.

12. The method of claim 1, wherein retrieving the data describing the monitored user activities comprises retrieving the data describing the monitored user activities according to a configurable monitor rule,
wherein reconciling the monitored user activities comprises reconciling the monitored user activities by retrieving supplemental information according to a configurable reconciliation rule, and
wherein aggregating the related user activities comprises aggregating the related user activities according to a configurable aggregation rule.

13. A system for monitoring and aggregating user activities across a plurality of heterogeneous systems in an enterprise network, comprising:
a monitor module configured for retrieving data describing monitored user activities from the plurality of heterogeneous systems, the plurality of heterogeneous systems generating the data responsive to the monitored user activities occurring in the plurality of heterogeneous systems;
a reconciliation module configured for reconciling the monitored user activities by retrieving supplemental information related to the monitored user activities from a reference system;
an aggregation and analysis module configured for aggregating related user activities using the supplemental information to generate an aggregation result, the related user activities being among the monitored user activities; and
a report module configured for reporting the aggregation result to an authorized user.

14. The system of claim 13, wherein at least one of the plurality of heterogeneous systems comprises a system selected from a group consisting of: a document management system, a mail system, a calendar system, a web server, a personal computer, a mobile phone, an Internet Protocol phone, and a personal digital assistant.

15. The system of claim 13, wherein at least one of the plurality of heterogeneous systems has a tracking function for recording local user activities and for generating data describing the local user activities, wherein the monitor module is further configured for:
accessing the tracking function of the at least one of the plurality of heterogeneous systems, and
retrieving the data describing the monitored user activities from the tracking function.

16. The system of claim 13, wherein the monitor module is further configured for retrieving the data from at least one of the plurality of heterogeneous systems through an Application Program Interface supported by the at least one of the plurality of heterogeneous systems.

17. The system of claim 13, wherein the aggregation and analysis module is further configured for:
identifying a plurality of different user activities, at least two of the plurality of different user activities occurring in different heterogeneous systems,
determining that the plurality of different user activities are related, and
aggregating the plurality of related different user activities into the aggregation result.

18. The system of claim 13, wherein the monitor module is further configured for converting the data describing the monitored user activities into a standard format.

19. The system of claim 13, wherein the reconciliation module is further configured for:
identifying data describing a same user activity, and
combining the data describing the same user activity into combined data describing the same user activity, wherein retrieving the supplemental information comprises retrieving supplemental information related to the same user activity based on the combined data.

20. The system of claim 13, wherein the supplemental information comprises cross-referencing information, and wherein the aggregation and analysis module is further configured for aggregating the related user activities using the cross-referencing information to generate the aggregation result.

21. The system of claim 13, wherein the aggregation and analysis module is further configured for aggregating the related user activities based on an attribute of the related user activities, the attribute selected from a group consisting of: a client who is related to the related user activities, a user who performed the related user activities, a business matter related to the related user activities, and a date when the related user activities occurred.

22. The system of claim 13, wherein the aggregation and analysis module is further configured for generating an attribute for the aggregated related user activities, the attribute comprising at least one selected from a group consisting of: a description of the related user activities, a total amount of time for the related user activities, and a common client of the related user activities, wherein the aggregation result comprises the attribute.

23. The system of claim 13, wherein the report module is further configured for outputting information related to the aggregation result to a resource management system.

24. The system of claim 13, wherein the monitor module is further configured for retrieving the data describing the monitored user activities according to a configurable monitor rule,
wherein the reconciliation module is further configured for reconciling the monitored user activities by retrieving supplemental information according to a configurable reconciliation rule, and
wherein the aggregation and analysis module is further configured for aggregating the related user activities according to a configurable aggregation rule.

25. A computer program product having a computer readable medium having computer program code contained therein, the computer program code comprising:
instructions for retrieving data describing monitored user activities from the plurality of heterogeneous systems, the plurality of heterogeneous systems generating the data responsive to the monitored user activities occurring in the plurality of heterogeneous systems;
instructions for reconciling the monitored user activities by retrieving supplemental information related to the monitored user activities from a reference system;
instructions for aggregating related user activities using the supplemental information to generate an aggregation result, the related user activities being among the monitored user activities; and
instructions for reporting the aggregation result to an authorized user.

26. The computer program product of claim 25, wherein at least one of the plurality of heterogeneous systems comprises a system selected from a group consisting of: a document management system, a mail system, a calendar system, a web server, a personal computer, a mobile phone, an Internet Protocol phone, and a personal digital assistant.

27. The computer program product of claim 25, wherein at least one of the plurality of heterogeneous systems has a tracking function for recording local user activities and for generating data describing the local user activities, wherein the instructions for retrieving the data describing the monitored user activities comprises:
instructions for accessing the tracking function of the at least one of the plurality of heterogeneous systems; and
instructions for retrieving the data describing the monitored user activities from the tracking function.

28. The computer program product of claim 25, wherein the instructions for retrieving the data describing the monitored user activities comprises instructions for retrieving the data from at least one of the plurality of heterogeneous systems through an Application Program Interface supported by the at least one of the plurality of heterogeneous systems.

29. The computer program product of claim 25, wherein the instructions for aggregating the related user activities comprises:
instructions for identifying a plurality of different user activities, at least two of the plurality of different user activities occurring in different heterogeneous systems;
instructions for determining that the plurality of different user activities are related; and
instructions for aggregating the plurality of related different user activities into the aggregation result.

30. The computer program product of claim 25, wherein the computer program code further comprising instructions for converting the data describing the monitored user activities into a standard format.

31. The computer program product of claim 25, wherein the instructions for reconciling the monitored user activities comprises:
instructions for identifying data describing a same user activity; and
instructions for combining the data describing the same user activity into combined data describing the same user activity, wherein retrieving the supplemental information comprises retrieving supplemental information related to the same user activity based on the combined data.

32. The computer program product of claim 25, wherein the supplemental information comprises cross-referencing information, and wherein the instructions for aggregating the related user activities comprises:
instructions for aggregating the related user activities using the cross-referencing information to generate the aggregation result.

33. The computer program product of claim 25, wherein the instructions for aggregating the related user activities comprises instructions for aggregating the related user activities based on an attribute of the related user activities, the attribute selected from a group consisting of: a client who is related to the related user activities, a user who performed the related user activities, a business matter related to the related user activities, and a date when the related user activities occurred.

34. The computer program product of claim 25, wherein the instructions for aggregating the related user activities comprises:
instructions for generating an attribute for the aggregated related user activities, the attribute comprising at least one selected from a group consisting of: a description of the related user activities, a total amount of time for the related user activities, and a common client of the related user activities,
wherein the aggregation result comprises the attribute.

35. The computer program product of claim 25, wherein the instructions for reporting the aggregation result comprises instructions for outputting information related to the aggregation result to a resource management system.

36. The computer program product of claim 25, wherein the instructions for retrieving the data describing the monitored user activities comprises instructions for retrieving the data describing the monitored user activities according to a configurable monitor rule,
wherein the instructions for reconciling the monitored user activities comprises instructions for reconciling the monitored user activities by retrieving supplemental information according to a configurable reconciliation rule, and
wherein the instructions for aggregating the related user activities comprises instructions for aggregating the related user activities according to a configurable aggregation rule.
